(19) United States
(12) Patent Application Publication
(10) Pub. No.: US 2013/0320913 A1
(43) Pub. Date: Dec. 5, 2013

(54) MOBILE CHARGER DEVICE

(71) Applicant: JUMP SWITCH LLC, New York, NY (US)

(72) Inventor: Victor CHEN, Fanwood, NJ (US)

(21) Appl. No.: 13/906,040

(22) Filed: May 30, 2013

Related U.S. Application Data
(60) Provisional application No. 61/654,670, filed on Jun. 1, 2012.

(51) Int. Cl. H02J 7/00

(52) U.S. Cl. CPC H02J 7/0042
USPC 320/103; 320/107

(57) ABSTRACT

A mobile charger device including a first connector that electrically connects a first mobile device to the mobile charger device, a second connector that electrically connects a second mobile device to the mobile charger device, a connector element that electrically connects the first mobile device electrically connected by the first connector with the second mobile device electrically connected by the second connector, and a switch operable to select which one of the first and second mobile devices supplies power through the connector element to the other of the first and second mobile devices.

### RELATED APPLICATION

This application is a non-provisional based on U.S. Provisional Patent Application 61/654,670, filed Jun. 1, 2012, the contents of which are incorporated herein by reference in their entirety.

### FIELD

The present disclosure generally relates to the transfer of electrical power from one device to another device.

### SUMMARY

In exemplary embodiments, a mobile charger device may facilitate the transfer of electrical power from one mobile device to another device.

In one exemplary embodiment, a mobile charger device may electrically connect to a first mobile and second mobile device. The first mobile device may provide electrical power to the second mobile device. The mobile charger may electrically connect to the first mobile device via a first connector and an audio cable. The second mobile device may electrical connect to the second mobile via a second connector. The mobile charger may include connector element, such as a circuit board, which connects the power and ground wires of the audio cable and the power and ground wires of the first connector to the power and ground wires of the second connector.

In another exemplary embodiment, a mobile charger may include at least two connectors to transfer power from one mobile device to another mobile device. The mobile charger may electrical connect to a first mobile device via one of the connectors and also connect to a second mobile device via another one or the connectors. The mobile charger may also include one or more rechargeable batteries. The power and ground wires of each connector may connect to the leads of at least one of the rechargeable batteries of the mobile charger. The mobile charger may also include a manual switch which may change the connections between the batteries and the connectors. The power and ground wires of a first connector may be connected to the respective positive and negative terminals of first battery, while the power and ground wires of a second connector may be connected to the respective positive and negative terminals of second battery. The switch may control the direction of the flow of power from one connecting device to another connecting device. If the switch is toggled or changed, the connections may be switched so that the power and ground wires of the first connector are connected to the second battery and the power and ground wires of the second connector are connected to the first battery. The one or more batteries when connected, may pull or drain power from one mobile device and may provide the drained power to another mobile device.

### DESCRIPTION OF THE DRAWINGS

The features and advantages of the present disclosure will be more fully understood with reference to the following, detailed description when taken in conjunction with the accompanying figures, wherein:

FIGS. 1A-1B illustrate an apparatus for charging mobile devices according to exemplary embodiments.

FIGS. 2A-2C illustrates an apparatus for charging mobile devices connected to two different mobile devices according to exemplary embodiments.

FIG. 3 illustrates an apparatus for charging mobile devices according to exemplary embodiments.

FIGS. 4A-4B illustrate an apparatus for charging mobile devices according to exemplary embodiments.

FIG. 5 illustrates an apparatus for charging mobile devices according to exemplary embodiments.

### DETAILED DESCRIPTION

The present disclosure generally relates to devices and methods for transferring electrical power from one mobile device to another mobile device. The drawing figures are not necessarily drawn to scale and certain figures may be shown in exaggerated or generalized form in the interest of clarity and conciseness.

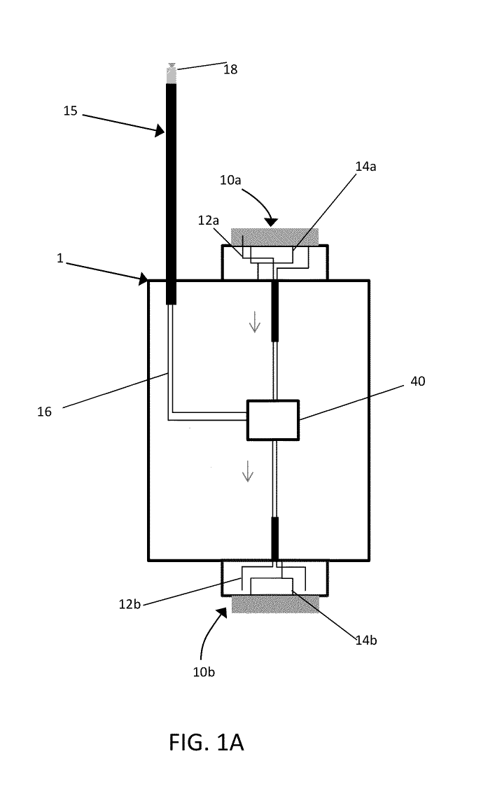

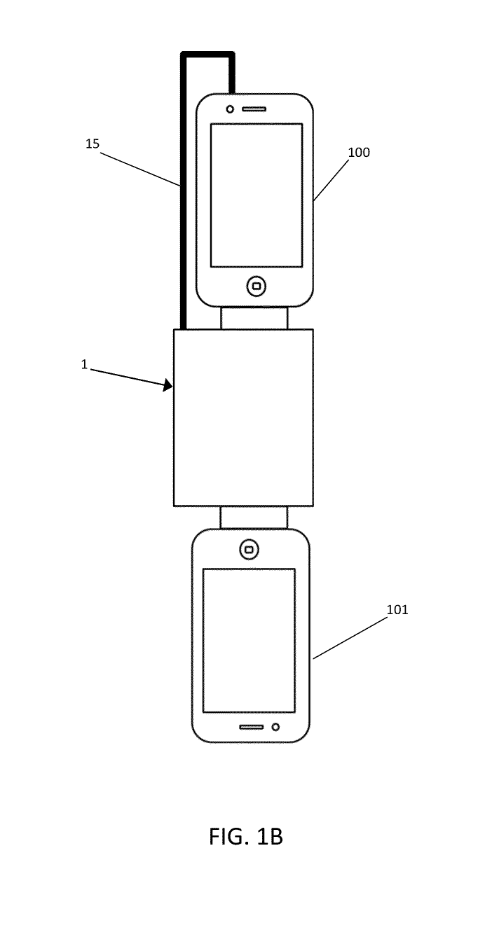

FIG. 1A illustrates an apparatus for charging a mobile device according to exemplary embodiments. The apparatus or mobile charger, generally designated by reference number 1 may facilitate the transfer of power from one mobile device to another mobile device.

In exemplary embodiments, the mobile charger 1 may be used with any mobile non-laptop device, such as, for example mobile phones, smartphones (e.g., iPhone®, Android® devices, Blackberry® devices, tablets devices (e.g., iPad®, Android® tablet), to name a few. FIG. 1B illustrates mobile device charger 1 connected to a pair of mobile devices 100 and 101, such as an iPhone®. The present invention is not intended to be limited to iPhone mobile devices but can be used with any compatible mobile device.

Referring to FIG. 1A, mobile charger 1 according to exemplary embodiments, may include a pair of connectors 10a, 10b, an audio cable 15, and a connector element 40. The connectors 10a and 10b may be any suitable type of connector which can electrically connect to the power source of a mobile device. While connectors 10a and 10b are illustrated as iOS type connectors e.g., compatible with iOS® devices (e.g., iPhone, iPad, iPod), connectors compatible with Android mobile devices, Windows® Phone mobile devices, and others, to name a few, may be used. In some exemplary embodiments, USB type including micro-USB, Firewire, Thunderbolt, HDMI, PDMI, audio, video, and other suitable connectors which can be used to transfer power from or to a mobile device may be used as a connector with mobile charger 1.

In exemplary embodiments, not all parts of a connector may be used with the mobile charger 1. For example, device connectors may include various pins and wires for different and/or specialized purposes, such as transferring data, and/or providing power. As illustrated in FIG. 1A, power and ground wires 12a, 12b which are connected to the power and ground pins of connector 10a and 10b may be electrically connected to other elements of the mobile charger 1, such as the connector element 40. Other wires 14a, 14b connected to other types of pins, e.g., audio, data, video, etc., may be unused and/or unconnected to the mobile charger 1.

In exemplary embodiments, the amount or number of power and ground wires 12a, 12b used with the mobile charger may vary depending on the particular type of connector and/or the particular type of mobile device used with the mobile charger 1.

In exemplary embodiments, the audio cable 15 may include a male audio plug 18 which may be inserted into the audio jack of a mobile device. For example, FIG. 1B shows the audio cable 15 connected to mobile device 100 via an audio jack (not shown). The audio plug 18 may be any audio plug which is compatible with audio jacks, including any used with mobile devices, such as, for example, a 35 mm audio jack. In the configuration shown in FIG. 1B, mobile device 100 is the source device which provides power to the target device, mobile device 101.

As illustrated in FIG. 1A, power and ground wires 16 of the audio cable 15 may be electrically connected to other elements of the mobile charger 1, such as the connector 40.

In exemplary embodiments, the connector 40 may be any element or device which electrically connects the wires 12a, 12b, and 16 together so power flows from mobile device 100 to mobile device 101. For example, the connector element 40 may be implemented as circuit board to electrical connect the power and ground wires 12a and the power and ground wires 16 to the power and ground wires 12b. By using a circuit board, the electrical power from the headphone jack and the dock of mobile device 100 may be combined and provided to mobile device 101. In some exemplary embodiments, other devices or elements, such as, for example, resistors, capacitors, transistors, wires, and other semiconductor devices, to name a few, may be used with or in place of a circuit board to electrical connect the power and ground wires 12a and the power and ground wires 16 to the power and ground wires 12b.

In an exemplary embodiment, the audio cable 15 may provide electrical power with a voltage of 3V (volts) from a mobile device. The wires 12a of connector 10a may provide electrical power which has a voltage of 1.8V. Providing power from at least two different electrical connections/sources of one mobile device may hasten the process of transferring electrical power from mobile device to another mobile device.

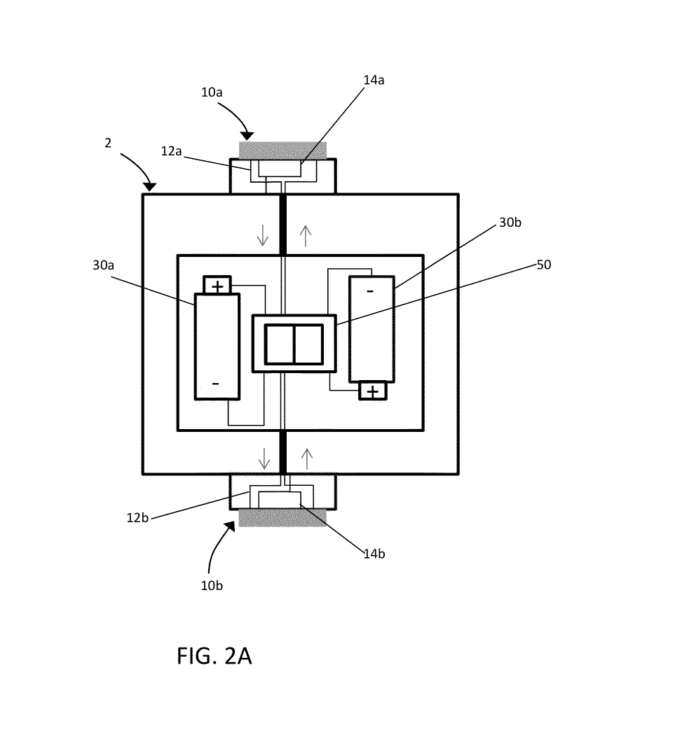

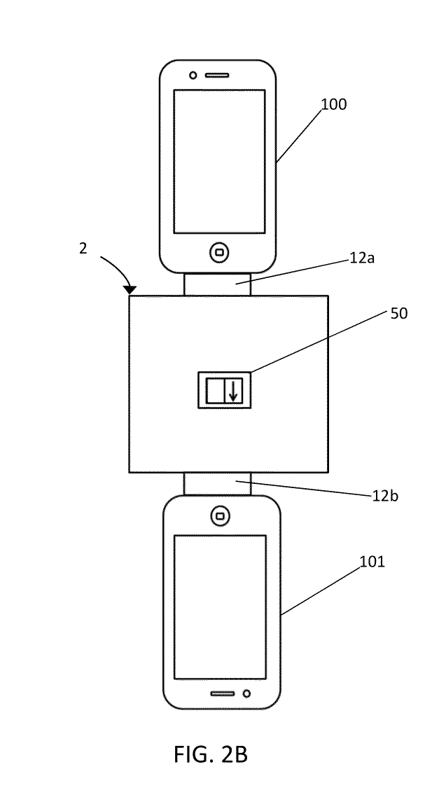

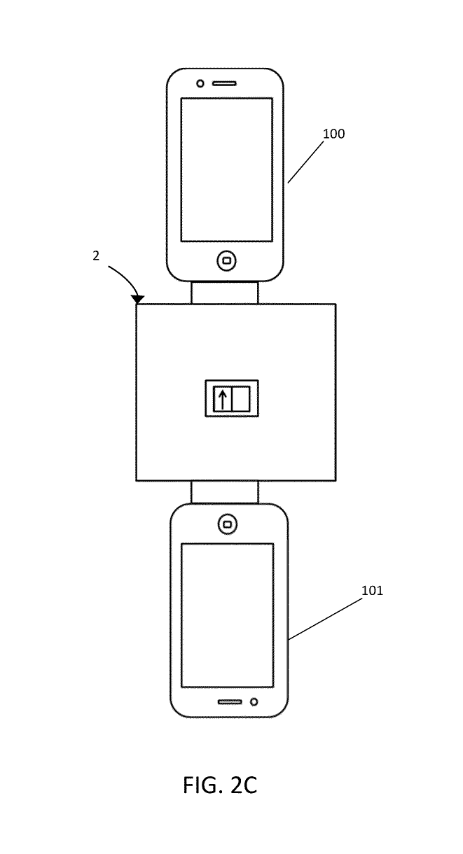

FIG. 2A illustrates an apparatus for charging a mobile device according to exemplary embodiments. The apparatus or mobile charger, generally designated by reference number 2 may facilitate the transfer of power from one mobile device to another mobile device.

Referring to FIG. 2A, mobile charger 2 according to exemplary embodiments, may include a pair of connectors 10a, 10b, one or more batteries 30a, 30b, etc. and a manual switch 50. As explained in the on text of FIGS. 1A-1B, the connectors 10a and 10b may be any suitable type of connector which can electrically connect to the power source of a mobile device. The power and ground wires 12a, 12b which are connected to the power and ground pins of connector 10a and 10b may be electrically connected to other elements of the mobile charger 2, such as the switch 50.

One or more rechargeable batteries may be used with the mobile charger 2, according to exemplary embodiments. FIG. 2A shows an exemplary embodiment of the mobile charger with rechargeable batteries 30a and 30b. In exemplary embodiments, the batteries may be connected to a switch 50. The switch 50 may be any suitable manual switch that can be changed by a user. The position of the switch may determine which direction electrical power can flow. In exemplary embodiments, slide switches, flip switches, knobs, buttons, or other manually-controllable flow direction devices can be used.

Referring to FIG. 2B, the switch 50 has been positioned so electrical power flows from mobile device 100 to mobile device 101. In FIG. 2C, the switch 50 has been changed or toggled so that electrical power flows from mobile device 101 to mobile device 100. In other words, the switch 50 may determine which connected mobile device can act as a target for receiving electrical power, and which connected mobile device can act as a source for providing electrical power.

In exemplary embodiments, the switch 50 may include changeable connections. For example, the switch 50 may include changeable connections between the rechargeable batteries 30a, 30b and the power and ground lines, 12a, 12b of the connectors 10a, 10b. For example, referring to FIG. 1, the leads or terminals of rechargeable battery 30a may be connected to the power and ground lines 12a of connector 10a, while the leads or terminals of rechargeable battery 30b may be connected to the power and ground lines 12b of connector 10b. In some exemplary embodiments, the batteries 30a and 30b may be connected to each other in parallel or in series. Further, one or more intermediary batteries may be connected in series or in parallel to batteries 30a and 30b.

In exemplary embodiments, a toggling of the switch 50 may alter or change one or more connections. For example, changing the position of the switch 50 may determine the connections between the batteries and one or more connectors 10a and 10b. For example, when the switch is in one position, the power and ground wires 12a of connector 10a may be connected to the respective positive and negative terminals of battery 30a, while the power and ground wires 12b of connector 10b may be connected to the respective positive and negative terminals of battery 30b. If the switch is toggled, the power and ground wires 12a of connector 10a may be connected to the respective positive and negative terminals of battery 30b, while the power and ground wires 12b of connector 10b may be connected to the respective positive and negative terminals of battery 30a.

In this regard, the switch 50 may control the direction of the flow of power from one connecting device to another connecting device. In some exemplary embodiments, a first battery, such as battery 30a or 30b, may pull or drain power from a source mobile device and provide the drained power to a second battery, either directly or through an intermediary battery. The second battery, either battery 30a or 30b, may receive and supply the drained power to a target mobile device.

In embodiments, other power draining, power transferring, and/or electrical storage means may be used with or instead of the batteries in order to transfer power from one device to another.

In exemplary embodiments, other components may be included or substituted with any of the mobile chargers described herein to improve performance, such as, for example transistors, resistors, comparators, voltage regulators, and capacitors, to name a few.

In exemplary embodiments, the connectors 10a and 10b may be removable and replaceable. For example, one or more other connectors, that may compatible with different devices may be substituted and used with any of the mobile chargers described herein. In this regard, if connector 10a is an iOS device type connector, an Android/Blackberry/etc. type connector may be substituted and used for power transferring according to exemplary embodiments described herein.

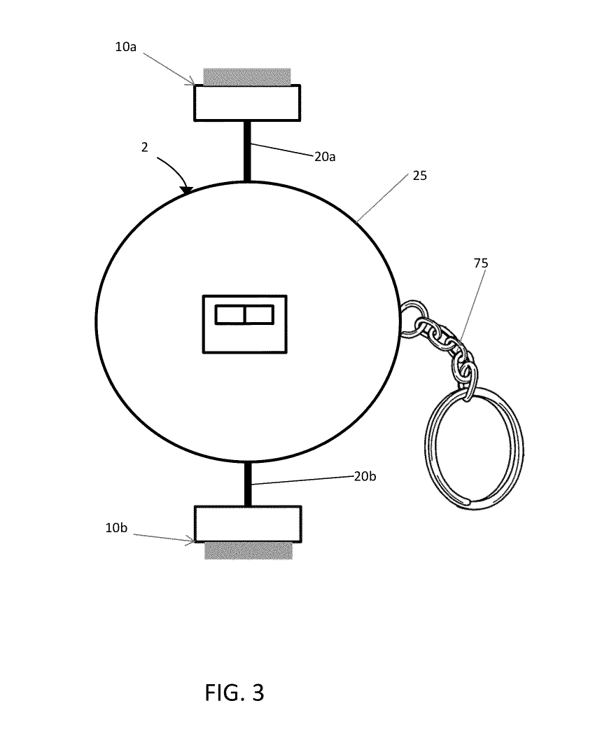

In exemplary embodiments, any of the mobile chargers described herein may have various shapes and sizes. FIG. 3 shows the mobile charger 2 according to an exemplary embodiment. The mobile charger 2 may include a casing 25, which can be in any suitable shape, such as, for example, rectangular, polygonal, circular, oval, or any other suitable three-dimensional shapes. Further, the casing 25 may any suitable size and may include or be connected to a key chain link 75.

In exemplary embodiments, mobile charger 2 may include one or more cables. For example, referring to FIG. 3, cables 20a and 20b may attach to connectors 10a and 10b respectively. For example, cable 20a may include and/or enclose at least a section of lines/wires 12a, and similarly cable 20a may include and/or enclose at least a section of lines/wires 12b. The cables may be flexible and allow a user to easily connect the mobile charger 1 to a mobile device.

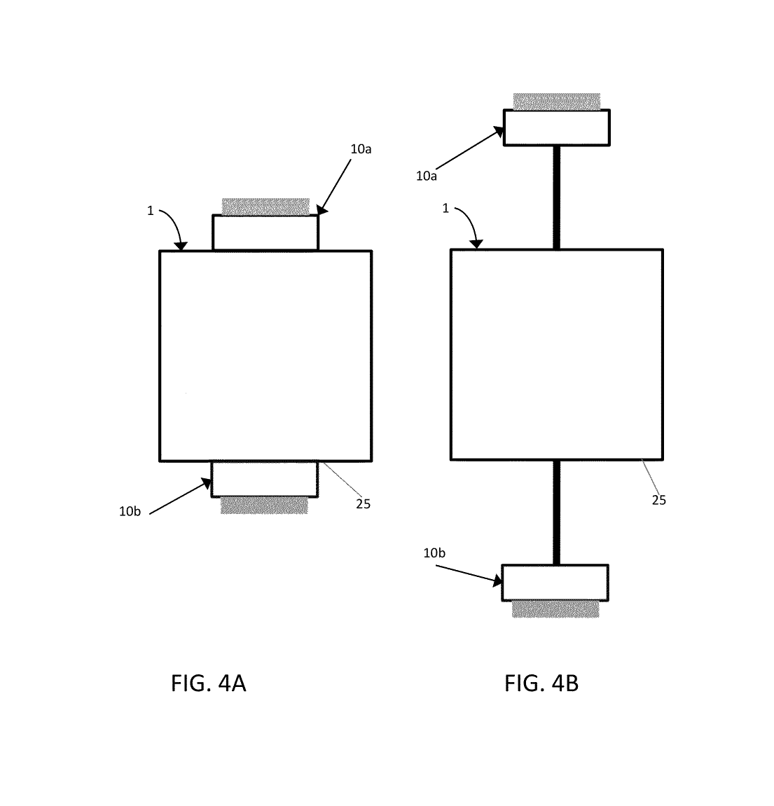

FIG. 4A and FIG. 4B show mobile charger 1 according to an exemplary embodiment. The mobile charger 1 may have retractable cables 20a and 20b. For example, the mobile charger 1 may include one or more reversible retraction mechanisms (not shown) coupled and/or connected to the cables 20a and/or 20b. In this regard, such a retraction mechanism may allow a user to pull and extend cables 20a, 20b away from casing 25. The retraction mechanism may also cause the cables 20a and 20b to be fully retracted within the casing 25. For example, in FIG. 4A the cables 20a, 20b are not shown because they are retracted and within the casing 25, and therefore the connectors 10a and 10b are shown immediately outside and adjacent to the casing 25. By contrast, FIG. 4B, shows mobile charger 1 with cables 20a and 20b in an extended position. As shown in FIG. 4B, the connectors 10a and 10b are located a distance away from the casing 25. In some exemplary embodiments, the retraction mechanism may include a locking mechanism to allow a user to pull and lock/fix cables 20a and/or 20b at variable distances away from the casing without a retracting force acting to pull cables 20a and/or 20b back toward the casing 25. The cable may remain held at the fixed length until further action is undertaken by the user to unlock and allow the cables 20a and/or 20b to be retracted.

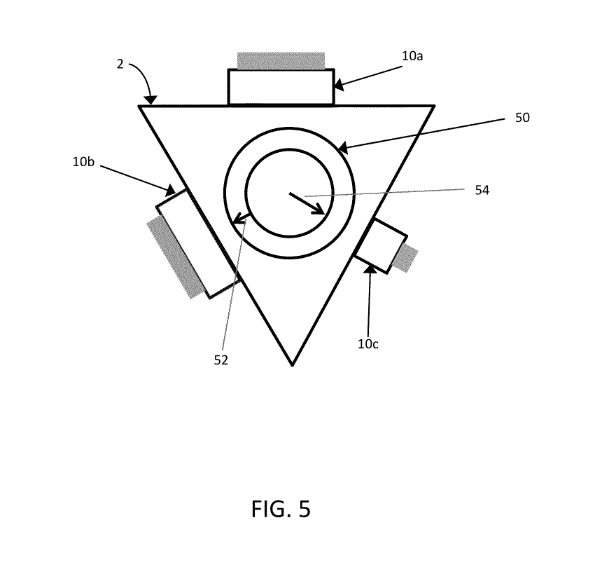

FIG. 5 shows the mobile charger 2 according to an exemplary embodiment. As described herein, the mobile charger 2 may have various shapes and may include any suitable number of connectors. Referring to FIG. 5, the mobile charger 2 has connectors 10a, 10b, and 10c. In exemplary embodiments, the connectors may be of the same type, or one or more may vary from each other. As shown in FIG. 5, connectors 10a and 10b may be iOS type connectors, and connector 10c may be a USB-type connector. The switch 50, as shown in FIG. 5, may include rotary dials 52 and 54 for selecting a target and a source device by changing the connections between the connectors and the batteries. For example, the outer dial 52 may select a source device to provide electrical power to a target device. Similarly, the inner dial 54 may be rotated to select a target device for receiving electrical power from the source device. The mobile charger 2 of FIG. 5 therefore permits more combinations of devices to be used. In other exemplary embodiments, the number of connectors included with the mobile charger 2 can be increased and therefore the number different devices and combinations to transfer power from one device to another can be increased.

It will be understood that that any of the above steps and/or elements can be combined, separated, any combination and/or separation thereof, and/or taken in any order. For ease, the steps are described as being sequential and/or in order. This is merely for ease and is not in any way meant to be a limitation.

Now that exemplary embodiments of the present disclosure have been shown and described in detail, various modifications and improvements thereon will become readily apparent to those skilled in the art.

What is claimed is:

1. A mobile charger device comprising:
a first connector that electrically connects a first mobile device to the mobile charger device;
a second connector that electrically connects a second mobile device to the mobile charger device;
a connector element that electrically connects the first mobile device electrically connected by the first connector with the second mobile device electrically connected by the second connector; and
a switch operable to select which one of the first and second mobile devices supplies power through the connector element to the other of the first and second mobile devices.

2. The mobile charger device of claim 1, further comprising an audio cable adapted for electrical connection to one of the first and second mobile devices, the audio cable being electrically connected to the connector element so that electrical power may be provided by the one of the first and second mobile devices through the audio cable to the other of the first and second mobile devices.

3. The mobile charger device of claim 1, wherein the connector element comprises components selected from the group consisting of: a circuit board, a resistor, a capacitor, a transistor, a wire, a semiconductor device, and combinations thereof.

4. The mobile charger device of claim 1, wherein the audio cable provides electrical power with a voltage of 3V from the selected one of the first and second mobile devices.

5. The mobile charger device of claim 1, wherein the first and second connectors provide electrical power with a voltage of 1.8V from the selected one of the first and second mobile devices.

6. The mobile charger device of claim 1, further comprising one or more batteries that drain power from the selected one of the first and second mobile devices and supply power to the other of the first and second mobile devices.

7. The mobile charger device of claim 6, wherein the one or more batteries comprise at least two batteries connected in series.

8. The mobile charger device of claim 6, wherein the one or more batteries comprise at least two batteries connected in parallel.

9. The mobile charger device of claim 1, wherein the switch comprises a type of switch selected from the group consisting of: a slide switch, a flip switch, a knob and a button.

10. The mobile charger device of claim 1, wherein at least one of the first and second connectors is an iOS device type connector.

11. The mobile charger device of claim 1, wherein at least one of the first and second connectors is a USB device type connector.

12. The mobile charger device of claim 1, wherein at least one of the first and second connectors comprises a flexible cable.

13. The mobile charger device of claim 1, wherein the flexible cable is retractable.
